(19) United States
(12) Patent Application Publication
(10) Pub. No.: US 2026/0213799 A1
(43) Pub. Date: Jul. 23, 2026

(54) LOCATION-BASED CANDIDATE BEAM LIST

(71) Applicants: Amit KALHAN, San Diego, CA (US); Kyocera Corporation, Kyoto (JP)

(72) Inventors: Amit KALHAN, San Diego, CA (US); Henry CHANG, San Diego, CA (US)

(21) Appl. No.: 19/157,776

(22) PCT Filed: Feb. 29, 2024
(86) PCT No.: PCT/US2024/017795

§ 371 Date: Aug. 19, 2025

Related U.S. Application Data
(60) Provisional application No. 63/451,271, filed on Mar. 10, 2023.

(51) Int. Cl. H04B 7/0456; H04W 24/08; H04W 64/00

(52) U.S. Cl. CPC H04B 7/0456; H04W 24/08; H04W 64/00

(57) ABSTRACT

A network node determines a location of a target terminal device and transmits a location-based CBL to the target terminal device. The location-based CBL comprises information identifying at least one reference signal. The target terminal device measures the at least one reference and conveys results of the measurements to the communication node. The network node applies a MU-MIMO precoder to transmissions through multiple antennas to the target terminal device where the MU-MIMO precoder is selected based, at least partially, on the results of the measurement of the at least one reference signal. In some embodiments, the location-based CBL is based, at least partially, on a precoder-to-region mapping comprising a plurality of region precoders mapped to a plurality of regions. The location-based CBL may further be based on the most recent precoder information received from a reporting neighbor terminal device that is within a maximum distance from the target terminal device.

### CLAIM OF PRIORITY

The present application claims priority to Provisional Application No. 63/451,271, entitled “Candidate Beams List Signaling,” docket number TPRO 00385 US, filed Mar. 10, 2023, assigned to the assignee hereof and hereby expressly incorporated by reference in its entirety.

### FIELD

This invention generally relates to wireless communications and more particularly to Multiple User Multiple Input Multiple Output (MU-MIMO) transmission precoder management with location-based Candidate Beam List (CBL).

### BACKGROUND

Many wireless communication systems that employ several base stations that provide wireless service to user equipment (UE) devices enable sidelink communication between two or more UE devices where the UE devices can communicate directly with other UE devices. In addition, one or more UE devices can be used as relay devices between a source UE device and a destination UE device where the relay devices forward data received from the source UE device to the destination UE device. In many conventional communication systems, a serving base station (serving gNB) applies a precoder matrix to transmissions to the UE devices through multiple antennas at the base station. Some systems utilize Multiple User Multiple Input Multiple Output (MU-MIMO) techniques for transmission of signals from multiple antennas at a base station to multiple UE device where a MU-MIMO precoder matrix is applied to the transmissions to enhance the achievable data rates of the transmission to each UE device. With MU-MIMO, a multi-antenna transmitter communicates simultaneously with multiple receivers. Each receiver may have one or multiple antennas. The MU-MIMO precoder facilitates beam forming or other communication channel adjustments where transmission antenna beams are formed to maximize the signal strength of each stream directed to each target UE device.

### SUMMARY

A network node determines a location of a target terminal device and transmits a location-based CBL to the target terminal device. The location-based CBL comprises information identifying at least one reference signal. The target terminal device measures the at least one reference and conveys results of the measurements to the communication node. The network node applies a MU-MIMO precoder to transmissions through multiple antennas to the target terminal device where the MU-MIMO precoder is selected based, at least partially, on the results of the measurement of the at least one reference signal. In some embodiments, the location-based CBL is based, at least partially, on a precoder-to-region mapping comprising a plurality of region precoders mapped to a plurality of regions. The location-based CBL may further be based on the most recent precoder information received from a reporting neighbor terminal device that is within a maximum distance from the target terminal device.

### BRIEF DESCRIPTION OF THE DRAWINGS

FIG. 1 is a block diagram of a system for an example where a network node transmits a location-based CBL to a target terminal device.

FIG. 2 is a block diagram of an example of a base station suitable for use as the network node.

FIG. 3 is a block diagram of an example of a UE device suitable for use as each of the terminal devices.

FIG. 4 is a message diagram for an example of location-based CBL transmission where a target user equipment (UE) device is in the RRC CONNECTED state.

FIG. 5 is a message diagram for an example of location-based CBL transmission where a target user equipment (UE) device is in an RRC state other than the CONNECTED state.

FIG. 6 is a flow chart of a method of transmitting a location-based CBL.

FIG. 7 is a flow chart of a method of receiving a location-based CBL.

### DETAILED DESCRIPTION

As discussed above, a serving base station (serving gNB) using MU-MIMO may apply a MU-MIMO precoder (such as a MU-MIMO precoder matrix) to transmissions to the UE devices through multiple antennas at the base station. The channel from the multiple antennas of the base station to an antenna of a UE device is a correlated random vector with covariance matrix that depends on the scattering geometry. Where the base station is a macro-cellular tower-mounted base station with no significant local scattering, the propagation between the base station antennas and any given UE device antenna is characterized by the local scattering around the UE device, resulting in the one-ring model. The signal vector received by the UE devices is given by

$$y = {H}^{H} Wd + z = {H}^{H} x + z$$

where M is the number of base station antennas, K is the number of UE devices, H denotes the M×K system channel matrix given by stacking the K users channel vectors by columns, W is the M×S precoding matrix with S is the rank of the input covariance Σ= [symbol] [Wdd^{H}W^{H}] (i.e., the number of independent data streams sent to the users), d is the S-dimensional transmitted data symbol vector, and z~ [symbol] (0, I) denotes the Gaussian noise at the UE device receiver. The transmit signal vector is given by x=Wd. After appropriate partitioning of the UE devices such that users in the same group are nearly co-located and different groups are sufficiently well separated in the angle of arrival (AoA) domain, the structure of the channel covariance matrices can be leveraged to reduce the dimensionality of the effective channels. As a result, large multiplexing gains are achieved with reduced dimension channel training and Channel State Information (CSI) feedback. The precoding matrix can be split to be a product of two precoders (W=W₁W₂). The two precoders may include a wideband precoder, W₁, and a UE-specific precoder, W₂. With such a precoder product structure, W₂ selects vectors from the wideband W₁ and adjusts the phase between the selected beams. As a result, the wideband and long-term CSI properties are addressed by W₁ while the short-term and frequency-selective CSI properties are addressed by W₂. The required update rate in time and frequency differs between W₁ and W₂. For W₁, the update frequency can be relatively low while the update rate for W₂ is higher.

The resulting precoder in MU-MIMO, therefore, is a combination of the individual precoders. In one example, each precoder is represented by a matrix and the combination of precoders is the product of the matrices. In practice, precoders are implemented by applying a complex-gain (amplitude and phase) weight to each antenna element which can be done in the digital or analog domain or partially in the digital domain and partially in the analog domain (hybrid MIMO processing). The precoding algorithms that compute the antenna weights for each antenna element can be sub-divided into linear and nonlinear precoding types. Nonlinear algorithms result in the maximum data rate achievable for given channel conditions. Although the capacity achieving algorithms are nonlinear, linear precoding technologies typically provide reasonable performance with less complexity. Examples of linear precoding strategies include maximum ratio transmission (MRT), zero-forcing (ZF) precoding, and transmit Wiener precoding. Nonlinear precoding is based on the concept of dirty paper coding (DPC), where any known interference at the transmitter can be subtracted without the penalty of radio resources if the optimal precoding scheme can be applied on the transmit signal.

For at least some of the examples discusses herein, a network node determines the location of a target terminal device and transmits a location-based Candidate Beam List (CBL) to the target terminal device where the location-based CBL identifies at least one reference signal. The target terminal device measures the at least one reference signal and the network node applies a MU-MIMO precoder to transmissions to the target terminal device that is at least partially based on the measurements or results of the measurements. In some examples, the network node may generate the location-based CBL based on precoder information provided by one or more neighbor UE devices. In some situations, the location-based CBL may be based on a precoder-to-region mapping maintained by the network node where the precoder-to-region mapping identifies one or more precoders that correspond to a geographical region or geographical location. The precoder-to-region mapping may be established during a data compiling or training period where terminal devices report precoder information or other feedback allowing the network node to determine which precoders are best for each region or location. In some situations, maintaining the precoder-to-region mapping includes continual adjustments, refinements or other changes based on additional information acquired during operation of the system. For example, a machine learning (ML) or artificial intelligence (AI) process may continually manage the mapping.

Such techniques reduce the communication overhead and latency of the precoder selection process since the target terminal device may be able to avoid conventional measurements, more quickly provide feedback to the network node, and/or provide measurements reports or other messages related to the precoder management that require fewer communication resources.

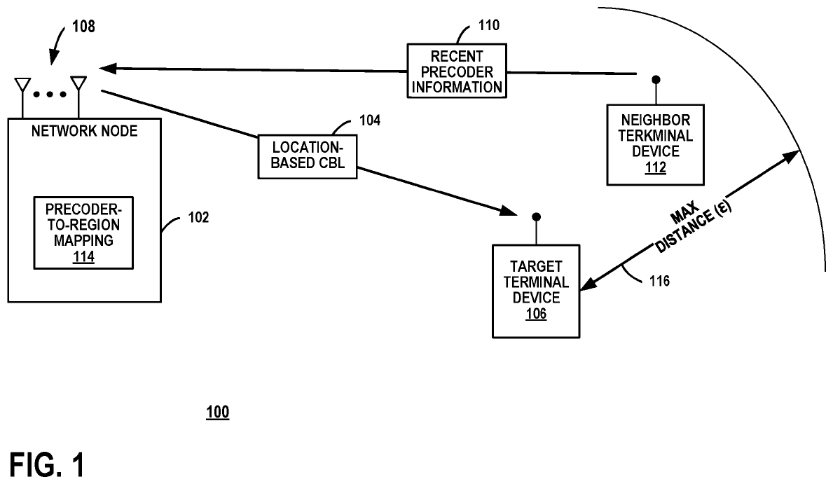

FIG. 1 is a block diagram of a system 100 for an example where a network node 102 transmits a location-based CBL 104 to a target terminal device 106. As discussed below in further detail, the network node 102 includes multiple antennas 108 and applies a MU-MIMO precoder to transmissions through the multiple antennas 108 to terminal devices. The network node 102 is any apparatus, equipment, device, or combination of devices, on the network side of the communication system that is connected to the communication network or is part of communication network. Some examples of a network node include a base station, a node B, an E-UTRA Node B, Evolved Node B, eNodeB, eNB, a New Generation eNB (ng-eNB), a gNodeB (also known as a gNB) in new radio (NR) technology, a macro station, pico station, and a femto station. The network node may form, or be a part of, the radio access network (RAN) that provides a connection between the core network and terminal communication devices. A RAN may be organized into three functional blocks including a Radio Unit (RU), a Distributed Unit (DU) and a Centralized Unit (CU). The RU transmits, receives, amplifies, and digitizes radio frequency signals and typically located near, or integrated into, the antenna. The DU and CU perform computations and/or processing to send and receive digitalized radio signals to and from the core network. The DU is typically located at or near the RU and the CU may be closer to the core network. The infrastructure or connection between the RU and the DU is often referred to as fronthaul and the infrastructure or connection between the DU and the CU is often referred to as a midhaul. The communication node, therefore, may perform the functions of one or more of the RU, DU and/or CU depending on the particular implementation.

A terminal communication device is a communication device on the terminal side of the communication system and is sometimes referred to as user equipment (UE), a UE device, a terminal device, wireless mobile device, wireless communication device and other terms. Some examples of a terminal communication device include a mobile phone, a smart phone, a personal digital assistant (PDA), tablet, and laptop computer. In some situations, the terminal communication device is a machine type communication (MTC) communication device or Internet-of-Things (IOT) device. In addition, the terminal communication device may be, or may be a part of, a wearable device or a vehicle where the vehicle may be terrestrial vehicle, watercraft, or aircraft (including unmanned aerial vehicles). The terminal communication device, therefore, is any fixed, mobile, or portable equipment that performs the functions of the terminal device described herein.

For the example of FIG. 1, the network node 102 determines the location of the target terminal device 106 and transmits a location-based CBL 104 to the target terminal device 106 based on the target terminal device location. Some examples of techniques for determining the location of and/or tracking the location/position of terminal devices include, but are not limited to information obtained via the global navigation satellite system (GNSS), the global positioning system (GPS), the Galileo public regulated service, positioning reference signal (PRS), sounding reference signal (SRS) for positioning, device-to-device (D2D)-assisted positioning technologies, neighbor lists, radar, light detection and ranging (LiDAR), and camera-based position techniques. Accordingly, the network node 102 may determine the location of the target terminal device 106 based on information received from the target terminal device 106, information received from one or more terminal devices, information provided by other system infrastructure, measurements performed by the network node 106, and any combination thereof.

At least partially based on the location/position of the target terminal device 106, the network node 102 generates, or otherwise determines, a location-based CBL identifying at least one reference signal. In some examples, the location-based CBL comprises information identifying a plurality of reference signals. For the example of FIG. 1, the location-based CBL is based on the location of target terminal device, precoder information 110 provided by at least one neighbor terminal device 112, and a precoder-to-region mapping 114. The network node 102 uses information from neighbor terminal device(s) with a maximum distance 116 from the target terminal device where the maximum distance 116 may be dynamic, fixed, or based on other factors which may include factors related to time of day and week, current conditions, the number of terminal devices near the target terminal device, speed of the target terminal device, and the variability of channel conditions based on location. The location-based CBL, however, may be based on the location of the target terminal device 106 and the most recent precoder information received from one or more neighbor terminal devices 112 and is not based on a precoder-to-region mapping 114. In still other situations, the location-based CBL 104 may be based on the location of the target terminal device 106 and a precoder-to-region mapping 114 and is not based on precoder information received from any neighbor terminal device 112.

The recent precoder information 110 is any information that, at least partially, facilitates in the selection at the network node 102 of the MU-MIMO precoder for transmissions to the neighbor terminal device 112. The recent precoder information 110 may include signal measurements made by the neighbor terminal device of downlink signals, such as reference signals. The recent precoder information 110 may also be an index identifying a particular precoder. For example, the neighbor terminal device 112 may evaluate precoded reference signals transmitted by the network node 102 to identify a preferred reference signal and may transmit an index from a codebook identifying the preferred reference signal. The recent precoder information 110 is information generated within a relatively short time before the network node 102 generates the location-based CBL 104 for transmission to the target terminal device 106. For the example, the time period is on the order of milliseconds. In some situations, however, the recent precoder information may include information received from a neighbor terminal device at time more than a second before generating the location-based CBL. In some examples, therefore, an AI or ML system generates a precoder-to-region mapping that includes a list of precoders for a region based on training data. The recently received precoder information from a neighboring terminal device assists in down-selecting or refining the above precoder list for a region. Typically, during a high cell-load, the MRU can be maintained at the rate of milliseconds or seconds. Since the network node 102 is tracking the location, or is otherwise aware of, the location of the neighbor terminal device 106, the network node 102 is able to associate the recent precoder information 110 and/or the resulting MU-MIMO precoder to the location of the neighbor terminal device 112. Although FIG. 1 shows a single neighbor terminal device 112, the network node 102 may receive recent precoder information 110 from multiple neighbor terminal devices within the maximum distance 116 from the target terminal device and may base the location-based CBL 104 to on all the information received. In some situations, the information received from different neighbor terminal devices may be weighted differently in generating the location-based CBL. For example, recent precoder information received from terminal devices closer to the target terminal device 106 may be weighted higher than information from terminal device farther away from the target terminal device 106. The recent precoder information may also be weighted differently based on the time the information was received where more recent information is weighted higher than older information.

As mentioned above, the precoder-to-region mapping may be established during a data compiling or training period where terminal devices report precoder information or other feedback allowing the network node to determine which precoders are best for each region or location. Accordingly, the network node 102 maintains a precoder-to-region mapping comprising a plurality of regions mapped to a set of regional plurality precoders where the precoder-to-region mapping based on long-term precoder information received from reporting terminal devices over a time period prior to reception of the recent precoder information. In addition, the precoder-to mapping may continue to be revised or adjusted based on new information acquired during operation of the system 100. In some embodiments, the precoder-to-region mapping 114 is learned from a plurality of samples, where each sample comprises a distinct position value and a corresponding precoder. In one embodiment, the precoder-to-region mapping function is learned from the plurality of samples using a machine learning model. Examples of machine learning models that can be used to learn the precoder-to-region mapping function include, but are not limited to: artificial neural network (ANN), case-based reasoning model, decision tree model, inductive logic programming, Gaussian process model, genetic algorithm, Kernel estimators, Gaussian naive Bayes classifier, maximum entropy classifier, conditional random field, nearest neighbor algorithm, linear regression model, logistic regression model, support vector machine (SVM), random forest, ensembles of classifiers. In some embodiments, the precoder-to-region mapping function is learned from a plurality of samples using an ANN model, wherein each sample comprises a distinct position value and a corresponding precoder. Based on the distinct positions and precoders, geographical regions can be defined where a particular precoder, or a limited set of precoders, may at least be estimated to likely apply for each region. In some situations, therefore, the precoder-to-region mapping includes at least one precoder that is mapped to a region and may include a plurality of precoders that are mapped to the region. Further, a particular precoder may be mapped to multiple regions. Each mapped precoder may provide the entire MU-MIMO precoder that is applied to signals transmitted to terminal devices in the region or may provide a portion of the MU-MIMO precoder. For example, where the MU-MIMO precoder is combination of a wide-beam precoder and a narrow-beam precoder, the precoder-to-region mapping 114 may include a mapping of wide-beam precoders to regions. Such an example may be implemented where the precoder-to-region mapping includes a mapping of Synchronization Signal Blocks (SSBs) to regions. A SSB number may be associated with one or more regions.

As mentioned above, the network node 102 generates the location-based CBL 104 based on the region in which the target terminal device is located, current precoder information 110 received from one or more neighbor terminal devices and the precoder-to-region mapping 114. In some examples, a ML algorithm generates the location-based CBL 104 based on data related to these parameters. One or more examples of ML techniques discussed above related to the precoder-to-region mapping may be suitable for generating the location-based CBL 104.

The location-based CBL 104 provides indicators, indices, parameters, or other information to the target terminal device 106 to inform the target terminal device 106 of the reference signals that should be measured. In some situations, the reference signals identified in the location-based CBL are precoded reference signals and the location-based CBL identifies the communication resources that will be used to transmit the reference signals from the network node. In other situations, the reference signals are non-precoded reference signals and the location-based CBL identifies precoders to apply to the reference signals in addition to the communication resources that will be used to transmit the reference signals. The location-based CBL, however, identifies a subset of reference signals available to the network node 102.

In some examples, the target terminal device 106 is in the Radio Resource Control (RRC) CONNECTED state when receiving the location-based CBL 104. In other examples, the target terminal device 106 is in an RRC state other than CONNECTED such as RRC IDLE or RRC INACTIVE. For the examples where the target terminal device 106 is RRC CONNECTED, the location-based CBL is transmitted over dedicated signaling. Some examples of such transmissions include transmitting the CBL via RRC, medium access control-control element (MAC-CE), and/or DL control information (DCI). Where the target terminal device is in IDLE or INACTIVE, the location-based CBL is broadcasted in at least the direction of the target terminal device 106. In some examples, the location-based CBL is broadcasted in a paging message. Such a technique may be particularly useful in situations where the target terminal device is receiving an incoming call or is otherwise being paged by the network. The location-based CBL may be sent over enhanced page message where the enhanced page message is transmitted within different regions and includes the CBL for the particular region where the target terminal device is determined to be located. Alternately, the location-based CBL may be transmitted only in the particular region where the target terminal device is determined to be located and legacy paging messages are sent in the other regions. Such a scheme ensures the target terminal device receives the page in the event the network node is using an inaccurate estimate of the location of the target terminal. In this way, the target terminal device can still perform the legacy connection establishment in the event of an inaccurate location estimate. In other examples, the location-based CBL is sent via SIB. An example of suitable SIB includes SIB1 since other SIBs may require the target terminal device to send a SIBRequest before the network node broadcasts those SIBs. Typically, SIBs are intended to be received by devices within the network node's coverage region rather than a specific region. Where the SIB is sent over multiple regions, therefore, the SIB may include location-based CBLs associated with multiple regions.

After measuring the reference signals, the target terminal device 106 provides feedback to the network node 102 based on the measurements and the network node 102 determines an appropriate MU-MIMO precoder for transmissions through the plurality of antennas 108 to the target terminal device 106 based on the feedback

In the examples below, the network nodes and terminal devices are represented by base stations and UE devices, respectively. The functions and operations performed by the base station and UE devices may be applied to other types of network nodes and terminal devices. The examples and embodiments are merely preferred examples and are not intended to limit the present disclosure. Accordingly, the system may include any desired combination of base stations, UE devices, and other equipment, while remaining within the scope of the present disclosure.

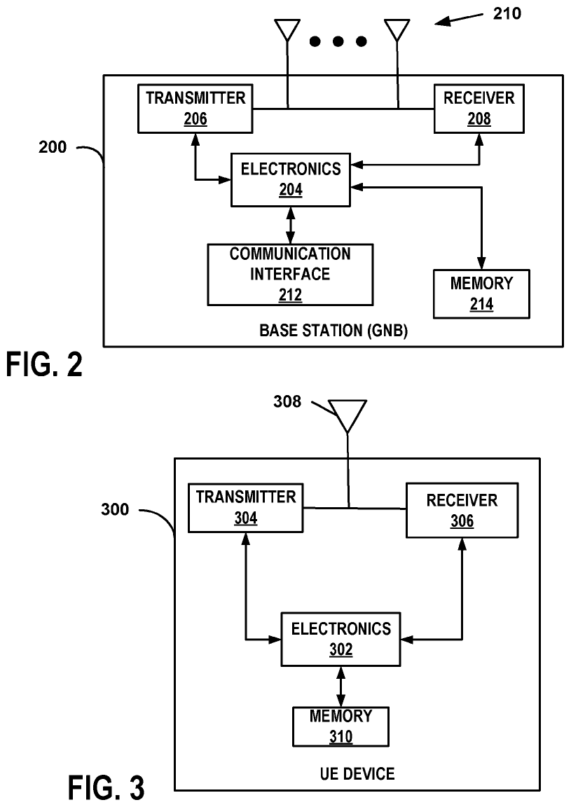

FIG. 2 is a block diagram of an example of a base station 200 suitable for use as the network node and base station 408. The base station 200 includes electronics 204, transmitter 206, a receiver 208, and multiple antennas 210, as well as other electronics, hardware, and code. The base station 200 is any fixed, mobile, or portable equipment that performs the functions described herein. The various functions and operations of the blocks described with reference to the base station 200 and network node 102 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The electronics 204 include any combination of hardware, software, and/or firmware for communicating with and controlling other base station components to execute the functions described herein as well as facilitating the overall functionality of the base station 200. The electronics 302, therefore, cooperatively operate with other base station 200 components to initiate tasks and perform the operations and functions of the base station 200. An example of suitable electronics 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 may receive signals through multiple antennas 210 or through a selected antenna of the plurality of antennas 210. The antennas 210 may include separate transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station 200.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders. The electronics 204 in conjunction with the transmitter 206 apply a precoder matrix to signals transmitted through the multiple antennas 210.

The base station 200 includes a communication interface 212 for communicating with other base stations and other network components, and other entities, such as servers and databases. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

The electronics 204, in conjunction with the receiver 208, measure and evaluate signals transmitted by UE devices. The electronics 204 and the receiver 206, therefore, can receive, measure, and evaluate uplink signals including reference signals transmitted by UE devices. Signal measurements and evaluations can be stored in a memory 214 and are used to determine the location of UE devices in some circumstances.

The electronics 204, in conjunction with the transmitter 206 and antennas 210, process outgoing signals to precode signals transmitted to UE devices. Accordingly, the electronics 204 and transmitter 206 apply the appropriate MU-MIMO precoder to signals transmitted to a specific UE device.

FIG. 3 is a block diagram of an example of a UE device 300 suitable for use as each of the terminal devices 106, 112 and UE devices 402, 404, 406, 502. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least electronics 302, a transmitter 304 and a receiver 306. The electronics 302 include any combination of hardware, software, and/or firmware for communicating with and controlling other UE device components to execute the functions described herein as well as facilitating the overall functionality of a communication device. The electronics 302, therefore, cooperatively operate with other UE device components to initiate tasks and perform the operations and functions of the UE device 300. An example of suitable electronics 302 includes code running on a microprocessor or processor arrangement connected to memory 310. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

The UE device 300 is capable of transmitting and receiving sidelink signals to and from other UE devices as well as communicating with base stations. The electronics 302, in conjunction with the receiver 306, measure an evaluate signals transmitted by other devices, such as base stations and UE devices. The electronics 302 and the receiver 306, therefore, can receive, measure, and evaluate downlink reference signals transmitted by a base station. Signal measurements and evaluations can be stored in the memory 310. The electronics 302 and receiver 306 can also receive, measure and evaluate discovery signals transmitted by nearby UE devices to generate a neighbor list that includes neighbor UE devices within the maximum distance. The neighbor list is stored in the memory 310 and may be transmitted to a base station.

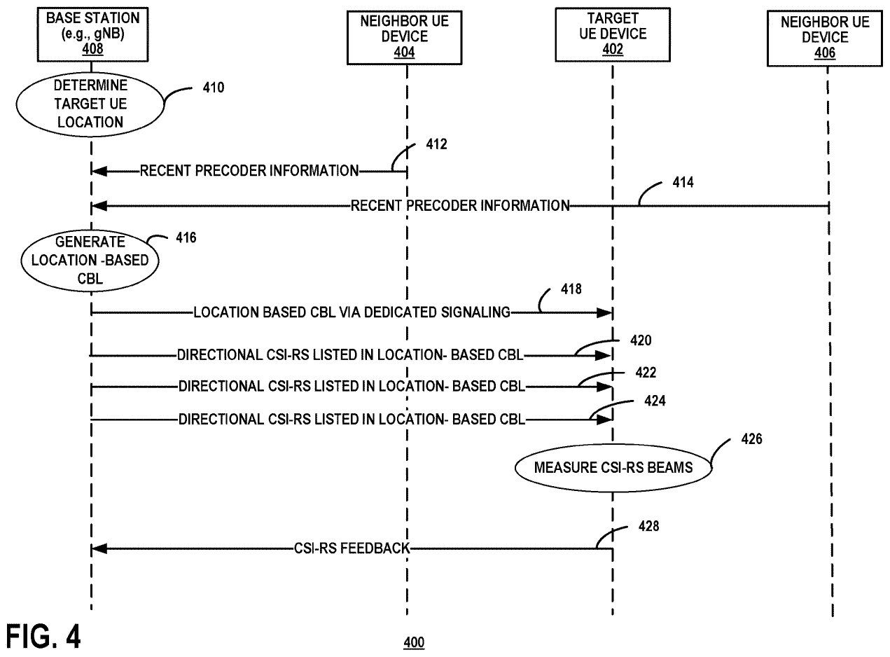

FIG. 4 is a message diagram 400 for an example of location-based CBL transmission where a target user equipment (UE) device 402 is in the RRC CONNECTED state. For the example, a first neighbor UE device 404 and a second UE neighbor device 406 are within the maximum distance from the target UE device 402. The target UE device 402 is an example of the target terminal device 106, the neighbor UE devices 404, 406 are examples of the neighbor terminal device 112, and the base station 408 is an example of the network node 102 discussed above.

At event 410, the base station 408 determines the location of the target UE device 402 The base station 408 may determine the location using any of several techniques which may include measurements by the base stations 404, evaluating signals and information received from UE devices, and conventional UE tracking procedures.

At transmission 412, the first neighbor UE device 404 transmits recent precoder information and, at transmission 414, the second neighbor UE device 406 transmits recent precoder information. The base station 408 determines the locations of neighbor UE devices and the distance between each neighbor UE device and the target UE device near or at the time of transmission of the precoder information.

At event 416, the base station 408 generates the location-based CBL for the target UE device 402. In one example, the base station includes beams corresponding to the previously reported information for the region in which the target UE device 402 is located and adds beams corresponding to information provided by the neighbor UE devices within the maximum distance of the target UE device. The location-based CBL may be generated using ML techniques. The location-based CBL may include the previously identified preferred beams for the region and/or may include new beams derived from current and/or previously received precoder information.

At transmission 418, the location-based CBL is transmitted to the target UE device using dedicated signaling. Since the target UE device is in the CONNECTED state, the base station 408 may use any suitable technique used to communicate directly with a UE device to convey the location-based CBL to the target UE device. Some examples include RRC, MAC-CE, and DCI transmissions.

At transmission 420, transmission 422, and transmission 424, the reference signals identified by the location-based CBL are transmitted in the direction of the target UE device.

The target UE device 402 receives and measures the transmissions 420, 422, 424 at event 426. Where the current beam being used for communication to the target UE device falls below a threshold, the target UE device may measure the transmissions 420, 422, 424 to select a better beam.

At transmission 428, the target UE device 402 provides feedback to the base station regarding the measured reference signals. For the example, the target UE device identifies the preferred reference signal from the plurality of reference signals where the preferred reference signal is the reference signal deemed to provide the highest quality communication link from the base station 408 to the target UE device 402. Accordingly, the target UE device provides precoder information based on the reference signal measurements. The precoder information or feedback may provided using an index from a codebook in some situations. Examples of other techniques for providing the feedback include providing the measurements of the reference signals taken by the targe UE device and indicating a precoder corresponding to the preferred reference signal.

For the example of FIG. 4, therefore, the target UE device is provided with a subset of reference signals in the location-based CBL where the subset is less than the reference signals the target UE device would measure in a conventional system. Such a technique reduces latency since the target UE device does not need to measure as many reference signals. In addition, communication traffic is reduced since the volume of feedback information provided by the target UE device is significantly reduced.

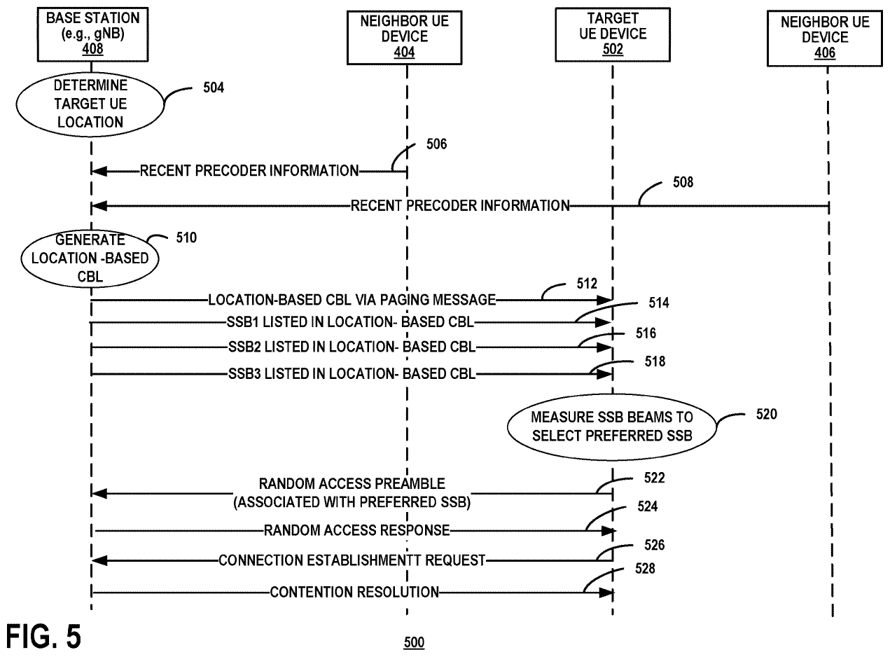

FIG. 5 is a message diagram 500 for an example of location-based CBL transmission where a target user equipment (UE) device 502 is in an RRC state other than the CONNECTED state. The target UE device 502, therefore, is in the RRC IDLE state or the RRC INACTIVE state. For the example, a first neighbor UE device 404 and a second UE neighbor device 406 are within the maximum distance from the target UE device 402. The target UE device 502 is an example of the target terminal device 106 discussed above.

At event 504, the base station 408 determines the location of the target UE device 502. The base station 408 may determine the location using any of several techniques which may include measurements by the base stations 404, evaluating signals and information received from UE devices, and conventional UE tracking procedures. In one example, the base station 408 determines the location based on one or more neighbor lists provided by neighbor devices. Since the target UE device is not in RRC CONNECTED, the target UE device does not send signals to the base station and some tracking techniques may not be available to the base station 404. However, the target UE device may still transmit sidelink (SL) or device-to-device (D2D) signals which are used by nearby devices to generate neighbor lists that include UE devices within a certain range. As a result, the neighbor lists at least provide a geographical area that includes to target UE device. In some situations, the target UE device may provide its location (e.g., GNSS coordinates) to a neighbor device which then includes the location in a neighbor list transmitted to the base station 408.

At transmission 506, the first neighbor UE device 404 transmits recent precoder information and, at transmission 508, the second neighbor UE device 406 transmits recent precoder information. The base station 408 determines the locations of neighbor UE devices and the distance between each neighbor UE device and the target UE device near or at the time of transmission of the precoder information.

At event 510, the base station 408 generates the location-based CBL for the target UE device 502. In one example, the base station includes SSBs corresponding to the previously reported information for the region in which the target UE device 502 is located and adds any SSB that corresponds to information provided by the neighbor UE devices within the maximum distance of the target UE device. The location-based CBL may be generated using ML techniques.

At transmission 512, the location-based CBL is broadcasted to the target UE device. As discussed above, different broadcasting techniques may be used to reach a device in IDLE or INACTIVE. In some examples, the location-based CBL is broadcasted in a paging message. Such a technique may be useful where the target UE device is being paged by the network. In other examples, the location-based CBL is broadcasted in a SIB, such as SIB1. Since the target UE device is in a state other than CONNECTED state, the base station 408 is unable to transmit the CBL using dedicated signaling. However, the base station 408 broadcasts the CBL in a message that is accessible by the target UE device in the IDLE or INACTIVE states. Accordingly, a paging message is used to convey the location-based CBL in the example. In some situations, a CBL information element (IE) may be used in the paging message to covey the location-based CBL.

At transmission 514, transmission 516, and transmission 518, the SSB reference signals identified by the location-based CBL are transmitted. The target UE device 502 receives and measures the transmissions 514, 516, 518 at event 520. Since the location-based CBL includes only a subset of the SSBs provided by the base station, the target UE device only needs to measure the identified SSBs in the location-based CBL and does not need to perform a full “sweep” of all SSBs identified in the SIB. The target UE device 502 evaluates the measurements and selects the best SSB as a preferred SSB.

At transmission 522, the target UE device 502 transits a signal to the base station 408 with a random access preamble where the preamble is associated with the preferred SSB selected by the target UE device. The random access response, the connection establishment request, and the contention resolution messages are transmitted at transmission 524, transmission 526, and transmission 528, respectively. Transmissions 524, 526, 528 are in accordance with conventional techniques.

For the examples discussed herein, the MU-MIMO precoder is the product of two precoders although, in some situations, may be based on more than two precoders. In such situations, a hierarchical precoder structure is implemented where each precoder provides an increased level of granularity to the previous precoder. For example, the MU-MIMO precoder may be the combination of a wide-beam precoder, an intermediate precoder, and a UE specific precoder where the wide-beam precoder provides the most general precoder parameters of the MU-MIMO precoder. The same wide-beam precoder, therefore, may be applicable to several UE devices within a maximum distance of each other. The intermediate precoder handles short-term and frequency-selective channel parameters of the MU-MIMO precoder and the UE-specific precoder provides the further short-term and frequency-selective channel parameters of the MU-MIMO precoder. In some situations, the intermediate precoder may apply to more than one UE device. Such a situation may be physically observed in an implementation where the MU-MIMO precoder facilitates antenna beams. For example, the wide-beam precoder may provide the widest antenna beam that applies to a first set of UE devices, the intermediate precoder provides intermediate-wide antenna beams narrower than and within the wide-beam antenna beam, and the UE-specific precoder provides the narrowest beams that are within the intermediate-wide antenna beam. As a result, an intermediate-wide antenna beam may apply to a narrower set of UE devices within a region where the UE devices in the narrower set are closer to each other than the UE devices in the first set.

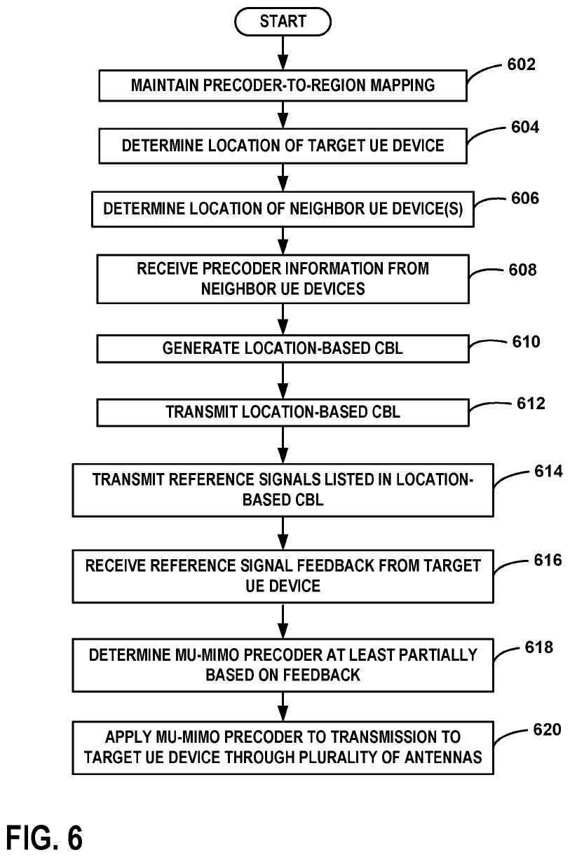

FIG. 6 is a flow chart of method of transmitting a location based CBL. The method may be performed in a system such eth system 100 discussed herein. In some situations, the method is performed by a network node 102. Accordingly, the method may be performed by a base station. The method may be performed using any of several techniques involving any combination of software, hardware, and firmware. For example, software code running on electronics including a processor, computer or other processor arrangement within the network node may facilitate the generation, formatting, and transmission of the location-based CBL. One or more of the steps may be omitted, combined, performed in parallel, or performed in a different order than that described herein or shown in FIG. 6. In still further examples, additional steps may be added that are not explicitly described in connection with the example discussed with reference to FIG. 6.

At step 602, a precoder-to-region mapping is maintained. For the example, the network node 102 compiles data received from multiple terminal devices over a data acquisition period to correlate precoders to regions.

At step 604, the location of a target terminal device is determined. The network node evaluates received signals and/or received information to demine the location of the target terminal device.

At step 606, the location(s) of a neighbor terminal devices is/are determined. The network node evaluates received signals and/or received information to demine the location of one or more neighbor terminal devices.

At step 608, current precoder information is received from the one or more neighbor terminal devices.

At step 610, a location-based CBL is generated for the location of the target terminal device.

At step 612, the location-based CBL is transmitted to the target terminal device. Where the target terminal device is in the RRC CONNECTED state, the location-based CBL is transmitted over dedicated signaling to the target terminal device. Where the target terminal device is in a state other than the RRC CONNECTED state (e.g., RRC IDLE, RRC INACTIVE), the location-based CBL is broadcasted in a paging message or SIB to the target terminal device.

At step 614, the reference signal identified in the location-based CBL are transmitted.

At step 616, feedback from the target terminal device is received. The target terminal device measures the reference signals and transmits precoder information based on the results of the measurements where the feedback may be the measurements results, an identification of a preferred reference signal identified from the measurements, an index identifying a precoder or reference signal, or other information that facilitates the network node in determining at least a portion of a precoder that is best used to transmit a precoded transmissions through the plurality of antennas to the target terminal device.

At step 618, a MU-MIMO precoder is selected, generated or otherwise determined at least partially based on the feedback (precoder information) received from the target terminal device. For the example, the MU-MIMO precoder is based at least on the precoder information and the precoder-to-region mapping.

At step 620, the MU-MIMO precoder determined at step 618 is applied to transmissions to the target terminal device through the plurality of antennas.

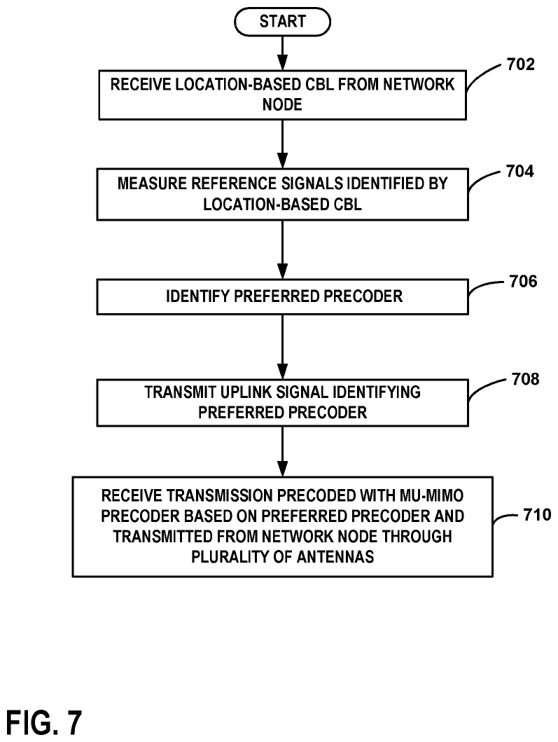

FIG. 7 is a flow chart of method of receiving a location-based CBL. The method may be performed in a system such the system 100 discussed herein. In some situations, the method is performed by a target terminal device. Accordingly, the method may be performed by a target UE device. The method may be performed using any of several techniques involving any combination of software, hardware, and firmware. For example, software code running on electronics including a processor, computer or other processor arrangement within the network node may facilitate the reception of signals, measurements, and transmissions related to the location-based CBL. One or more of the steps may be omitted, combined, performed in parallel, or performed in a different order than that described herein or shown in FIG. 7. In still further examples, additional steps may be added that are not explicitly described in connection with the example discussed with reference to FIG. 7.

At step 702, a location-based CBL is received at the target terminal device. Where the target terminal device is in the RRC CONNECTED state, the location-based CBL is received over dedicated signaling from the network node. Where the target terminal device is in a state other than the RRC CONNECTED state (e.g., RRC IDLE, RRC INACTIVE), the location-based CBL is received in a broadcasted paging message or SIB from the network node the target terminal device.

At step 704, the reference signals identified in the location-based CBL are received and measured.

At step 706, preferred reference signal is identified based on the measurements of the reference signals. The target terminal device identifies the refence signal associated with the best communication link from the network node.

At step 708, feedback regarding the reference signals measurements is provided to the network node. The target terminal device measures the reference signals and transmits precoder information based on the results of the measurements where the feedback may be the measurements results, an identification of a preferred reference signal identified from the measurements, an index identifying a precoder or reference signal, or other information that facilitates the network node in determining at least a portion of a precoder that is best used to transmit a precoded transmissions through the plurality of antennas to the target terminal device.

At step 710, a transmission from the network node is received where a MU-MIMO precoder applied to the transmission through a plurality of antennas. The MU-MIMO precoder is selected, generated or otherwise determined at least partially based on the feedback (precoder information) transmitted to the network node from the target terminal device. For the example, the MU-MIMO precoder is based at least on the precoder information and a precoder-to-region mapping maintained at the network node.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. The described functionality may be implemented in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to processors, devices, components, circuits, electronics, and equipment that are physically constructed, programmed, instructed and/or arranged to perform the specified operation or function. Furthermore, the various illustrative logical blocks, modules, devices, components and circuits described herein can be implemented within or performed by an integrated circuit (IC) that can include a general-purpose processor, a digital signal processor (DSP), an application specific integrated circuit (ASIC), other electronics or combinations thereof. (ASIC), a field programmable gate array (FPGA) or other programmable logic device, or any combination thereof. The logical blocks, electronics, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

When implemented in software, the functions can be stored as one or more instructions or code on a computer-readable medium. Thus, the steps of a method or algorithm disclosed herein can be implemented as software stored on a computer-readable medium. Computer readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

Therefore, the methods and apparatus of this invention may take the form, at least partially, of program logic or program code (i.e., instructions) embodied in tangible media, such as a machine-readable storage medium. When the program code is loaded into and executed by a machine, such as a computer, the machine becomes an apparatus for practicing the invention. The methods and apparatus of the present invention may also be embodied in the form of program code that is transmitted over some transmission medium, such as over electrical wiring or cabling, through fiber optics, or via any other form of transmission. When the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Therefore, references to specific functional units are only references to a suitable means for providing the described functionality, rather than indicative of a strict logical or physical structure or organization.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method comprising:
determining a location of a target terminal device;
at least partially in response to determining the location, transmitting a location-based Candidate Beam List (CBL) to the target terminal device, the location-based CBL comprising information identifying at least one reference signal; and
applying a Multiple User-Multiple Input Multiple Output (MU-MIMO) precoder to a data transmission to the target terminal device through a plurality of antennas, the MU-MIMO precoder selected, at least partially, based on measurement of the at least one reference signal by the target terminal device.

2. The method of claim 1, further comprising:
configuring the target terminal device to transmit an uplink signal identifying a preferred reference signal precoder.

3. The method of claim 2, wherein the at least one reference signal is a precoded reference signal and wherein the MU-MIMO precoder is based on the preferred reference signal precoder applied to the transmission of a preferred reference signal identified by the target terminal device.

4. The method of claim 3, wherein transmitting the location-based CBL comprises transmitting the location-based CBL as a user equipment (UE)-specific CBL in dedicated signaling to the target terminal device while the target terminal device is in a Radio Resource Configuration (RRC) CONNECTED state and wherein the uplink signal is an uplink control signal comprising a reference signal identifier identifying the preferred reference signal.

5. The method of claim 3, wherein transmitting the location-based CBL comprises broadcasting the location-based CBL in a System Information Block (SIB) to the target terminal device while the target terminal device is in a Radio Resource Configuration (RRC) state other than the CONNECTED state and wherein the uplink signal is transmitted with a preamble corresponding to the preferred reference signal.

6. The method of claim 5, wherein the SIB comprises a CBL information element (IE) identifying the reference signals.

7. The method of claim 3, wherein broadcasting the location-based CBL comprises broadcasting the location-based CBL in a paging message.

8. The method of claim 7, wherein the paging message comprises a CBL information element (IE) identifying the reference signals.

9. The method of claim 2, wherein the at least one reference signal is a non-precoded reference signal and wherein the MU-MIMO precoder is based on the preferred reference signal precoder identified by the target terminal device by applying a plurality of precoders to the at least one reference signal.

10. The method of claim 1, further comprising:
generating the location-based CBL at least partially based on recent precoder information received from a neighboring reporting UE device located within a maximum distance from the target UE device.

11. The method of claim 10, further comprising:
maintaining a precoder-to-region mapping comprising a plurality of regions mapped to a set of regional plurality precoders, the precoder-to-region mapping based on long-term precoder information received from reporting terminal devices over a time period prior to reception of the recent precoder information, wherein generating the location-based CBL comprises generating the location-based CBL at least partially on the precoder-to-region mapping.

12. A method comprising:
receiving, at a target terminal device, a location-based Candidate Beam List (CBL) comprising information based on a location of the target terminal device and identifying at least one reference signal;
measuring the at least one reference signal to identify a preferred reference signal precoder;
transmitting an uplink signal identifying the preferred reference signal precoder; and
receiving a data transmission transmitted through a plurality of antennas and precoded by a Multiple User-Multiple Input Multiple Output (MU-MIMO) precoder selected, at least partially, based on the preferred reference signal precoder.

13. The method of claim 12, wherein the at least one reference signal is a precoded reference signal and wherein the MU-MIMO precoder is based on the preferred reference signal precoder.

14. The method of claim 13, wherein receiving the location-based CBL comprises receiving the location-based CBL as a user equipment (UE)-specific CBL in dedicated signaling while the target terminal device is in a Radio Resource Configuration (RRC) CONNECTED state and wherein the uplink signal is an uplink control signal comprising a reference signal identifier identifying the preferred reference signal.

15. The method of claim 13, wherein receiving the location-based CBL comprises receiving a broadcasted System Information Block (SIB) comprising the location-based CBL while the target terminal device is in a Radio Resource Configuration (RRC) state other than the CONNECTED state and wherein transmitting the uplink signal comprises transmitting the uplink signal with a preamble corresponding to the preferred reference signal.

16. The method of claim 15, wherein the SIB comprises a CBL information element (IE) identifying the reference signals.

17. The method of claim 13 wherein receiving the location-based CBL comprises receiving the location-based CBL in a broadcasted paging message.

18. The method of claim 17, wherein the paging message comprises a CBL information element (IE) identifying the reference signals.

18. A network node comprising:
electronics configured to determine a location of a target terminal device;
a plurality of antennas; and
a transmitter configured to transmit, at least partially in response to determining the location, a location-based Candidate Beam List (CBL) to the target terminal device, the location-based CBL comprising information identifying at least one reference signal, the transmitter configured to apply a Multiple User-Multiple Input Multiple Output (MU-MIMO) precoder to a data transmission to the target terminal device through the plurality of antennas, the MU-MIMO precoder selected, at least partially, based on measurement of the at least one reference signal by the target terminal device.

20. A target terminal device comprising:
a receiver configured to receive, a location-based Candidate Beam List (CBL) comprising information based on a location of the target terminal device and identifying at least one reference signal;
electronics configured to measure the at least one reference signal to identify a preferred reference signal precoder; and
a transmitter configured to transmit an uplink signal identifying the preferred reference signal precoder,
the receiver configured to receive a data transmission transmitted through a plurality of antennas and precoded by a Multiple User-Multiple Input Multiple Output (MU-MIMO) precoder selected, at least partially, based on the preferred reference signal precoder.

21. A non-transitory computer readable medium storing computer-executable instructions which when executed perform the method of:
determining a location of a target terminal device;
at least partially in response to determining the location, transmitting a location-based Candidate Beam List (CBL) to the target terminal device, the location-based CBL comprising information identifying at least one reference signal; and
applying a Multiple User-Multiple Input Multiple Output (MU-MIMO) precoder to a data transmission to the target terminal device through a plurality of antennas, the MU-MIMO precoder selected, at least partially, based on measurement of the at least one reference signal by the target terminal device.
